(19) United States
(12) Patent Application Publication
(10) Pub. No.: US 2011/0158169 A1
(43) Pub. Date: Jun. 30, 2011

(54) METHOD OF TRANSMITTING CONTROL INFORMATION IN MOBILE COMMUNICATION SYSTEM AND METHOD OF ACKNOWLEDGING THE CONTROL INFORMATION

(75) Inventors: Jae Sun CHA, Daejeon (KR); Soojung Jung, Daejeon (KR); Eunkyung Kim, Seoul (KR); Sung Cheol Chang, Daejeon (KR); Kwang Jae Lim, Daejeon (KR); Hyun Lee, Daejeon (KR); Chul Sik Yoon, Seoul (KR)

(73) Assignee: Electronics and Telecommunications Research Institute, Daejeon (KR)

(21) Appl. No.: 12/978,819

(22) Filed: Dec. 27, 2010

(30) Foreign Application Priority Data
Dec. 28, 2009 (KR) 10-2009-0131657
Feb. 22, 2010 (KR) 10-2010-0015888
Dec. 22, 2010 (KR) 10-2010-0132713

(51) Int. Cl. H04W 4/00

(52) U.S. Cl. 370/328

(57) ABSTRACT

A method of acknowledgment by a receiver includes: receiving a control message via a payload of a medium access control protocol data unit (MAC PDU) from a transmitter or receiving control information through an extended header or signaling header of the MAC PDU; and transmitting an acknowledgment of the control message or control information through an acknowledgment extended header containing information about whether the acknowledgment is an acknowledgment of the control message or an acknowledgment of the control information.

### CROSS-REFERENCE TO RELATED APPLICATION

This application claims priority to and the benefit of Korean Patent Application No. 10-2009-0131657, 10-2010-0015888, and 10-2010-0132713 filed in the Korean Intellectual Property Office on Dec. 28, 2009, Feb. 22, 2010, and Dec. 22, 2010 the entire contents of which are incorporated herein by reference.

### BACKGROUND OF THE INVENTION

(a) Field of the Invention

The present invention relates to a mobile communication system, and more particularly, to a method for transmitting control information in a mobile communication system and a method of acknowledging the control information.

(b) Description of the Related Art

In a mobile communication system, a base station transmits, control information for controlling the state of a terminal to the terminal, and the terminal transmits an acknowledgment to the control information to the base station.

The base station may transmit a control message through a payload in a medium access control protocol data unit (MAC PDU), or may transmit control information through an extended header or signaling header in the MAC PDU.

The terminal having received the control message from the base station responds through a response-only control message or a response-only extended header. The terminal having received the control information through the extended header or signaling header in the MAC PDU acknowledges through the extended header or signaling header in the MAC PDU. That is, the terminal acknowledges the control message or control information received from the base station in various ways.

At this point, there are no clear criteria for determining whether to acknowledge through an acknowledgement control message or through an acknowledgment extended header after the terminal has received the control message, thus making the operation of the terminal ambiguous.

Moreover, when the terminal has received control information through an extended header or signaling header, acknowledgement through the extended header or signaling header leads to a problem in expandability and overhead.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of transmitting control information in a mobile communication system, and a method of acknowledging the control information.

A method of acknowledgment by a receiver according to an exemplary embodiment of the present invention includes: receiving a control message via a payload of a medium access control protocol data unit (MAC PDU) from a transmitter or receiving control information through an extended header or signaling header of the MAC PDU; and transmitting an acknowledgment of the control message or control information through an acknowledgment extended header containing information about whether the acknowledgment is an acknowledgment of the control message or an acknowledgment of the control information.

A method of acknowledgment by a receiver according to an exemplary embodiment of the present invention includes: receiving a control message via a payload of a medium access control protocol data unit (MAC PDU) from a transmitter or receiving control information through an extended header or signaling header of the MAC PDU; and transmitting an acknowledgment of the control message or control information through an acknowledgment extended header containing information about the type of the acknowledgment indicating both the acknowledgment or not of the control message and the acknowledgment or not of the control information.

A method of controlling control information by a transmitter according to an exemplary embodiment of the present invention includes: transmitting a control message via a payload of a medium access control protocol data unit (MAC PDU) from a transmitter or transmitting control information through an extended header or signaling header of the MAC PDU; and receiving an acknowledgment of the control message or control information through an acknowledgment extended header containing information about the type of acknowledgment.

### BRIEF DESCRIPTION OF THE DRAWINGS

FIGS. 1 and 2 are views showing a structure of a MAC PDU.

FIGS. 3 and 4 are flowcharts showing a general control information transmission and acknowledgement method.

FIGS. 5 and 6 are flowcharts showing a control information transmission and acknowledgment method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In this specification, a terminal may designate a mobile station (MS), a mobile terminal (MT), a subscriber station (SS), a portable subscriber station (PSS), user equipment (UE), an access terminal (AT), etc., and may include the entire or partial functions of the terminal, the mobile station, the mobile terminal, the subscriber station, the portable subscriber station, the user equipment, etc.

In this specification, a base station (BS) may designate an access point (AP), a radio access station (RAS), a Node B, an evolved Node B (eNodeB), a base transceiver station (BTS), a mobile multihop relay (MMR)-BS, etc., and may include the entire or partial functions of the access point, the radio access station, the node B, the eNodeB, the base transceiver station, the MMR-BS, etc.

In this specification, a transmitter may be a base station and a receiver may be a mobile station, or a transmitter may be a terminal and a receiver may be a base station.

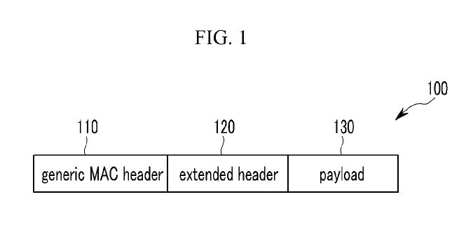

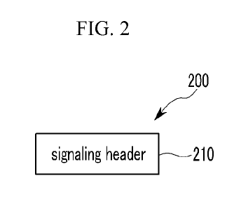

FIGS. 1 and 2 are views showing a structure of a MAC PDU.

Referring to FIG. 1, an MAC PDU 100 includes a generic MAC header 110, an extended header 120, and a payload 130. The MAC PDU 100 transmits data or a control message. The data or control message is transmitted in the form of the payload 130, and the extended header 120 may contain information indicating additional control information or the type of the payload. In the MAC PDU 100, the generic MAC header 110 may be an essential element, and the extended header 120 and the payload 130 may be additional elements. The MAC PDU 100 may include only the generic MAC header 110 and the extended header 120.

Referring to FIG. 2, the MAC PDU 200 includes a signaling header 210. The MAC PDU 200 is transmitted for control purposes only, and can reduce overhead since it has no generic MAC header.

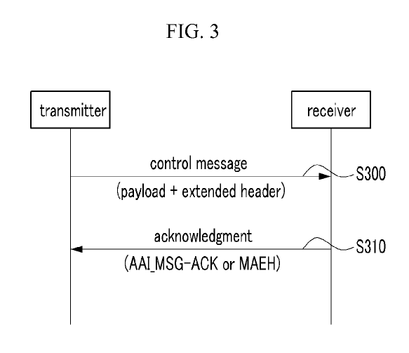

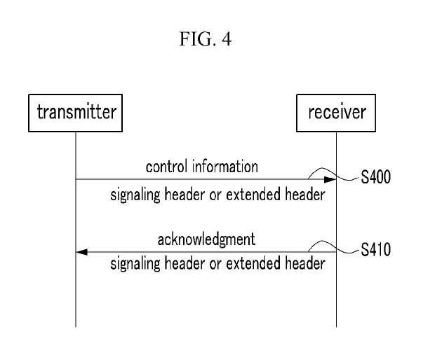

FIGS. 3 and 4 are flowcharts showing a general control information transmission and acknowledgement method.

Referring to FIG. 3, a transmitter transmits a control message through a payload 130 of a MAC PDU 100 (S300). An extended header 120 of the MAC PDU 100 may contain response request information on the control message. For example, if a specific bit (poll) of the extended header 120 is set to 1, it may indicate that the transmitter requests an acknowledgment of the message from the receiver.

The receiver having received the control message from the transmitter transmits an AAI_MSG-ACK message as an acknowledgement control message or a MAC control message ACK extended header (MAEH) as an acknowledgment extended header (S310).

Referring to FIG. 4, the transmitter transmits control information through the extended header 120 of the MAC PDU 100 or through the signaling header 210 of the MAC PDU 200 (S400). At this point, the transmitter may set a specific bit (response) of the extended header 120 of the MAC PDU 100 or of the signaling header 210 of the MAC PDU 200 to 0 to indicate an initial transmission requesting an acknowledgment from the receiver.

The receiver having received the control information from the transmitter transmits an acknowledgment in the same manner, i.e., through the extended header 120 of the MAC PDU 100 or through the signaling header 210 of the MAC PDU 200 (S410). At this point, the transmitter may set a specific bit (response) of the extended header 120 of the MAC PDU 100 or of the signaling header 210 of the MAC PDU 200 to 1 to indicate an acknowledgment of the initial transmission.

In the control information transmission and acknowledgment method of FIG. 3, there are no criteria for determining which of the AAI_MSG-ACK message and the MAEH the receiver having received the control message should choose.

The control information transmission and acknowledgment method of FIG. 4 is disadvantageous in terms of expandability and overhead because the receiver having received the control information acknowledges in the same manner. For example, each header has to add a specific bit for each new signaling header or extended header requiring acknowledgment, and the receiver has to acknowledge using different headers according to the type of the received header for purposes of the same acknowledgment. Moreover, unnecessary information needs to be contained because transmission has to be done in a defined format of the signaling header or extended header regardless of what content is contained in the acknowledgment. For example, a general signaling header is defined as 6 bytes. In this case, the receiver has to transmit a signaling header of 6 bytes only for acknowledgment.

To solve this problem, it is necessary to unify the type of acknowledgment of a control message or control information.

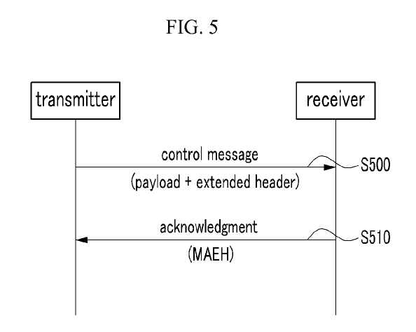

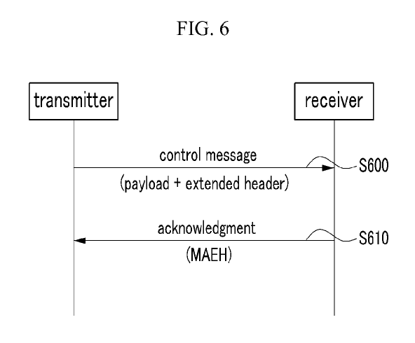

FIGS. 5 and 6 are flowcharts showing a control information transmission and acknowledgment method according to an exemplary embodiment of the present invention.

Referring to FIG. 5, a transmitter transmits a control message through a payload 130 of an MAC PDU 100 (S500). At this point, a specific bit (poll) of the extended header 120 may be set to 1 to request an acknowledgment from the receiver.

The receiver having received the control message from the transmitter transmits an acknowledgement through an MAEH (S510).

Referring to FIG. 6, the transmitter transmits control information through the extended header 120 of the MAC PDU 100 or through the signaling header 210 of the MAC PDU 200 (S600). At this point, the transmitter may set a specific bit (response) of the extended header 120 of the MAC PDU 100 or of the signaling header 210 of the MAC PDU 200 to 0 to indicate an initial transmission requesting an acknowledgment from the receiver.

The receiver having received the control information from the transmitter transmits an acknowledgment through an MAEH (S610).

As shown in FIGS. 5 and 6, the receiver having received the control message or control information from the transmitter transmits an acknowledgment through an MAEH regardless of the reception format. Accordingly, the type of acknowledgment by the receiver differs according to the type of the control message or control information, thus preventing difficulties in implementation of the receiver. Also, overhead and resource waste generated in the course of acknowledgment from the receiver can be reduced.

Table 1 shows the format of MAEH according to an exemplary embodiment of the present invention.

TABLE 1

| | Size | |
|---|---|---|
| Syntax | (bits) | Notes |
| MAEH ( ) { | | |
| type | 4 | |
| Ack_type | 1 | 0: acknowledgement to control |
| | | messages |
| | | 1: acknowledgement to signaling |
| | | headers or EHs |
| If (Ack_type == 0) { | | |
| Channel ID | 1 | |
| ACK_SN | 8 | |
| Reserved | 2 | For byte alignment |
| } | | |
| Else { | | |
| Ack_header_type | 5 | Bit #0: indicates the header |
| | | type to be acknowledged; 0: |
| | | signaling header, 1: extended |
| | | header |
| | | Bits #1-#4: header type |
| Frame_LSB | 6 | LBS of frame sequence |
| | | Indicates the frame in which |
| | | the header to be |
| | | acknowledged is transmitted |
| } | | |
| } | | |

In Table 1, Type is a parameter consisting of 4 bits and indicating that the current extended header is MAEH. Ack_type is a parameter consisting of 1 bit and indicating the transmission scheme of a control message or control information. For example, if Ack_type is set to 0, it indicates an acknowledgment of the control message, and if Ack_type is set to 1, it indicates an acknowledgment of the control information transmitted through a signaling header or extended header.

If Ack_type is 0, Channel ID indicates the number of a channel ID (identification) in which the control message is transmitted, and ACK_SN indicates a sequence number of the control message. Two reserved bits may be arranged to set the total length of an MAEH to 2 bytes.

If Ack_type is 1, Ack_header_type indicates the type of a header consisting of 5 bits in which control information is transmitted. For example, the first bit indicates whether the header for transmitting the control information is a signaling header or extended header, and the remaining bits indicate the type value of the header for transmitting the control information. Frame_LSB consists of 6 bits, and indicates when the header for transmitting the control information is transmitted. For example, Frame_LSB may indicate the lowest 6 bits of the frame number of the frame on which the header is received.

Table 2 shows the format of MAEH according to another exemplary embodiment of the present invention.

TABLE 2

| | Size | |
|---|---|---|
| Syntax | (bits) | Notes |
| MAEH ( ) { | | |
| type | 4 | |
| Ack_type | 1 | 0: acknowledgement to control |
| | | messages |
| | | 1: acknowledgement to |
| | | signaling headers or EHs |
| If (Ack_type == 0) { | | |
| Channel ID | 1 | |
| ACK_SN | 8 | |
| Reserved | 2 | For byte alignment |
| } | | |
| Else { | | |
| Do { | | |
| Ack_header_type | 5 | Bit #0: indicates the header |
| | | type to be acknowledged; 0: |
| | | signaling header, 1: |
| | | extended header |
| | | Bits #1-#4: header type |
| Frame_LSB | 5 | LBS of frame sequence |
| | | Indicates the frame that the |
| | | header to be acknowledged |
| | | is transmitted |
| End | 1 | 0: no more ack information |
| | | 1: more ack information |
| } while (End) | | |
| } | | |
| } | | |

In the case that the receiver has received control information through several headers, the format in Table 2 can be used to transmit an acknowledgment through one MAEH. Table 2 is the same as Table 1 except that, when Ack_type is 1, the MAEH further includes End. End indicates whether one MAEH contains several Ack_header_type and Frame_LSBs.

Table 3 shows the format of an MAEH according to still another exemplary embodiment of the present invention.

TABLE 3

| | Size | |
|---|---|---|
| Syntax | (bits) | Notes |
| MAEH ( ) { | | |
| type | 4 | |
| Ack_Indicator | 2 | Bit #0: indicates the inclusion |
| | | of an ACK to a control |
| | | message |
| | | Bit #1: indicates the inclusion |
| | | of an ACK to signaling |
| | | headers or extended headers |
| If (Bit #0 of | | |
| Ack_Indicator == 1) { | | |
| Channel ID | 1 | |
| ACK_SN | 8 | |
| Reserved | 1 | For byte alignment |
| } | | |
| If (Bit #1 of | | |
| Ack_Indicator == 1) { | | |
| Do { | | |
| Ack_header_type | 5 | Bit #0: indicates the header |
| | | type to be acknowledged; |
| | | 0: signaling header, 1: |
| | | extended header |
| | | Bits #1-#4: header type |
| Frame_LSB | 4 | LBS of frame sequence |
| | | Indicates the frame that the |
| | | header to be |
| | | acknowledged is |
| | | transmitted |
| End | 1 | 0: no more ack information |
| | | 1: more ack information |
| } while (End) | | |
| } | | |
| } | | |

The format in Table 3 can be used to simultaneously transmit an acknowledgment of a control message and acknowledgments of various control information through one MAEH. Unlike Tables 1 and 2, Table 3 includes Ack_Indicator of 2 bits. The 0-th bit of Ack_Indicator indicates an acknowledgment of a control message, and the first bit of Ack_Indicator indicates an acknowledgment of control information. That is, if Ack_Indicator is 11, it indicates that the corresponding MAEH includes both the acknowledgment of the control message and the acknowledgment of the control information. Meanwhile, to simultaneously transmit acknowledgments of various control information, Table 3 includes End, like Table 2, when the first bit of Ack_Indicator is 1.

Table 4 shows the format of MAEH according to yet another exemplary embodiment of the present invention.

TABLE 4

| | Size | |
|---|---|---|
| Syntax | (bits) | Notes |
| MAEH ( ) { | | |
| type | 4 | |
| Ack_Indicator | 2 | Bit #0: indicates the inclusion |
| | | of an ACK to a control |
| | | message |
| | | Bit #1: indicates the inclusion |
| | | of an ACK to signaling |
| | | headers or extended headers |
| If (Bit #0 of | | |
| Ack_Indicator == 1) { | | |
| Channel ID | 1 | |
| ACK_SN | 8 | |
| Reserved | 1 | For byte alignment |
| } | | |
| If (Bit #1 of | | |
| Ack_Indicator == 1) { | | |
| Do { | | |
| Ack_header_type | 5 | Bit #0: indicates the header |
| | | type to be acknowledged; |
| | | 0: signaling header, 1: |
| | | extended header |
| | | Bits #1-#4: header type |
| Frame_LSB | 3 | LBS of frame sequence |
| | | Indicates the frame that the |
| | | header to be |
| | | acknowledged is |
| | | transmitted |
| Response | 1 | 0: accept the request |
| | | 1: reject the request |
| End | 1 | 0: no more ack information |
| | | 1: more ack information |
| } while (End) | | |
| } | | |
| } | | |

The format in Table 4 can be used to simultaneously transmit an acknowledgment of a control message and acknowledgments of various control information through one MAEH. Table 4 has the same format as Table 3 except for Response when the first bit of Ack_Indicator is 1. Response indicates the acceptance or not of a request from the transmitter. That is, when the transmitter sends a request to change the state of the receiver or perform the operation of the receiver through a signaling header or extended header, the receiver can acknowledge the request from the transmitter through Response of the MAEH.

As seen from the above, the receiver can transmit an acknowledgment through an MAEH of 2 bytes regardless of the type of control message or control information transmitted by the transmitter, thus reducing the overhead of the receiver. Moreover, an acknowledgment of various control messages or an acknowledgment of control information can be made through one MAEH.

Accordingly, the type of acknowledgment by the receiver differs according to the type of control message or control information, thus preventing difficulties in implementation of the receiver. Also, overhead and resource waste generated in the course of acknowledgment from the receiver can be reduced.

The exemplary embodiments of the present invention are not implemented only by a device and/or method, but can be implemented through a program for realizing functions corresponding to the configuration of the exemplary embodiments of the present invention and a recording medium having the program recorded thereon.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of acknowledgment by a receiver, the method comprising:
receiving a control message via a payload of a medium access control protocol data unit (MAC PDU) from a transmitter or receiving control information through an extended header or signaling header of the MAC PDU; and
transmitting an acknowledgment of the control message or control information through an acknowledgment extended header containing information about whether the acknowledgment is an acknowledgment of the control message or an acknowledgment of the control information.

2. The method of claim 1, wherein, for an acknowledgment of the control message, the acknowledgment extended header further comprises a channel ID (identification) in which the control message is transmitted and a sequence number of the control message.

3. The method of claim 1, wherein, for an acknowledgment of the control information, the acknowledgment extended header further comprises the type of a header for transmitting the control information and the frame number of the frame on which the header for transmitting the control information is received.

4. The method of claim 3, wherein the acknowledgment extended header further comprises information of the number of acknowledgments contained in the acknowledgment extended header.

5. The method of claim 1, wherein the acknowledgment extended header has a length of 2 bytes.

6. The method of claim 1, wherein a request for an acknowledgment of the control message or the control information is sent to the receiver using a predetermined bit.

7. A method of acknowledgment by a receiver, the method comprising:
receiving a control message via a payload of a medium access control protocol data unit (MAC PDU) from a transmitter or receiving control information through an extended header or signaling header of the MAC PDU; and
transmitting an acknowledgment of the control message or control information through an acknowledgment extended header containing information about the type of the acknowledgment indicating both the acknowledgment or not of the control message and the acknowledgment or not of the control information.

8. The method of claim 7, wherein the information about the type of the acknowledgment consists of 2 bits, and
the first bit indicates whether the acknowledgment extended header contains an acknowledgment of the control message, and the second bit indicates whether the acknowledgment extended header contains an acknowledgment of the control information.

9. The method of claim 8, wherein, if the acknowledgment extended header contains an acknowledgment of the control message, the acknowledgment extended header further comprises a channel ID (identification) in which the control message is transmitted and a sequence number of the control message.

10. The method of claim 8, wherein, if the acknowledgment extended header contains an acknowledgment of the control information, the acknowledgment extended header further comprises the type of a header for transmitting the control information and the frame number of the frame on which the header for transmitting the control information is received.

11. The method of claim 10, wherein the acknowledgment extended header further comprises information of the number of acknowledgments contained in the acknowledgment extended header.

12. The method of claim 7, wherein the acknowledgment extended header has a length of 2 bytes.

13. The method of claim 7, wherein a request for an acknowledgment of the control message or the control information is sent to the receiver using a predetermined bit.

14. A method of controlling control information by a transmitter, the method comprising:
transmitting a control message via a payload of a medium access control protocol data unit (MAC PDU) from a transmitter or transmitting control information through an extended header or signaling header of the MAC PDU; and
receiving an acknowledgment of the control message or control information through an acknowledgment extended header containing information about the type of the acknowledgment.

15. The method of claim 14, wherein a request for an acknowledgment of the control message or the control information is sent to the receiver using a predetermined bit.

16. The method of claim 14, wherein the information about the type of the acknowledgment contains information indicating whether the acknowledgment is an acknowledgment of the control message or an acknowledgment of the control information.

17. The method of claim 14, wherein the information about the type of the acknowledgment contains indications of both the acknowledgment or not of the control message and the acknowledgment or not of the control information.
